(19) United States
(12) Patent Application Publication
(10) Pub. No.: US 2004/0093800 A1
(43) Pub. Date: May 20, 2004

(54) Device for pulling or pushing a door leaf

(76) Inventor: Rene Gumbau, Nice (FR)

Correspondence Address: YOUNG & THOMPSON, 745 SOUTH 23RD STREET 2ND FLOOR, ARLINGTON, VA, 22202

(21) Appl. No.: 10/469,169

(22) PCT Filed: Feb. 22, 2002
(86) PCT No.: PCT/EP02/01913

(30) Foreign Application Priority Data
Feb. 27, 2001 (FR) 0102617

(51) Int. Cl. E05F 11/00

(52) U.S. Cl. 49/326

(57) ABSTRACT

The invention relates to a device for pulling or pushing a door leaf (F) comprising: —a connecting rod (G2) positioned at the lower end of the door, said connecting rod (G2) being fixed in rotation with one end fixed to the lower part of the leaf (F) and the other end fixed to a post (A1) of the door jamb; —a connecting rod (G1) positioned at the upper end of the door, said connecting rod (G1) being fixed in rotation with one end fixed to the upper part of the leaf (F) and the other end fixed to the post (A1); —a carriage (D) is guided in translation inside a rail (C) which is embedded in the door lintel and which is fixed to the upper part of the leaf (F) by an axle (E).

The present invention relates to a device for “pulling or pushing” a swinging panel of a door.

There is meant by door any member for opening or closing an opening (including a window).

Generally, a door with a swinging panel takes up, when it is open, at least its width in room, which is to say the width of the swinging panel. Moreover, generally, a door with a lock opens in a single direction. Either it opens with a “pull”, or it opens with a “push”.

Unfortunately, doors with a swinging panel have several major drawbacks:

1. for a person in a wheelchair, to open a door with a swinging panel, with opening in a single direction, is a real challenge. The size of the door, during opening, requires the person in a wheelchair not only to lean over for a total opening, so as to permit him to pass through, but moreover leaves him only a single hand to propel his wheelchair. A person in a wheelchair must make several attempts to open a single door.

2. a door with a swinging panel that takes up at least its width when it is open, which is to say the width of the swinging panel, occupies very precious space in certain locations (in particular when opening on corridors).

This is why the double object of the invention is to facilitate opening and closing of the door for all users, as well as to reduce its size.

Double opening: “pull-push”:

1. more uncertainty as to the direction of opening, which gives this door the advantage of solving problems of security.

2. for persons in wheelchairs, for the passage of stretchers or gurnies, opening such a door is no longer such a problem. It permits them to enter and leave a locality simply by pulling or pushing, as desired.

Reduced size of the opening:

For persons in wheelchairs, this door no longer represents an insurmountable architectural barrier.

Not only:

1. it is no longer necessary to lean into it to open it totally, it takes only a single hand to effect total opening of the door

2. it takes only once to open the door with a wheelchair.

3. it is adapted to save space in homes, hospitals, schools and sports complexes, hotels, rest homes, restaurants, etc . . . anywhere that ease of access and saving of space are necessary.

There is moreover known from GB-A-2 213 185 a door with combined translation and rotation movements. The securement structure on the frame of this door is however complicated.

The present invention solves this problem by providing an easier mounting of the door by a particular support structure of the swinging panel, applicable to openings of all types.

In particular, “U” shaped plates ensure both the reception of the pivot of the links for movement of the swinging panel and the support of the rail for translation.

The present invention relates to a device for “pulling or pushing” a swinging panel of a door, comprising:

a link in the lower position of the door, said link being fixed in rotation by one end on the lower portion of the swinging panel and by its other end on an upright of the door frame,

a link in the upper position of the door, said link being fixed in rotation by one end on the upper portion of the swinging panel and by the other end to the upright,

a carriage guided in translation within a rail embedded in the door lintel of the door and fixed on the upper portion of the swinging panel by an axle.

According to preferred modifications, the device is such that:

it comprises a first U shaped plate secured to the upright and on which is fixed in rotation the other end of the link,

it comprises a second U shaped plate secured to the other upright of the door, said U shaped plates fixing and supporting the rail,

it comprises a guide in the lower position of the rail,

it comprises

4 vertical covers fixed against the two vertical uprights of the door,

2 horizontal covers fixed on the rail,

4 springs permitting assembling in the upper position the four vertical covers to the two horizontal covers,

it comprises two vertical strips each fixed to the center of a vertical upright.

The accompanying drawings are given by way of indicative examples and are not limiting. They show a preferred embodiment according to the invention. They permit easy understanding of the invention.

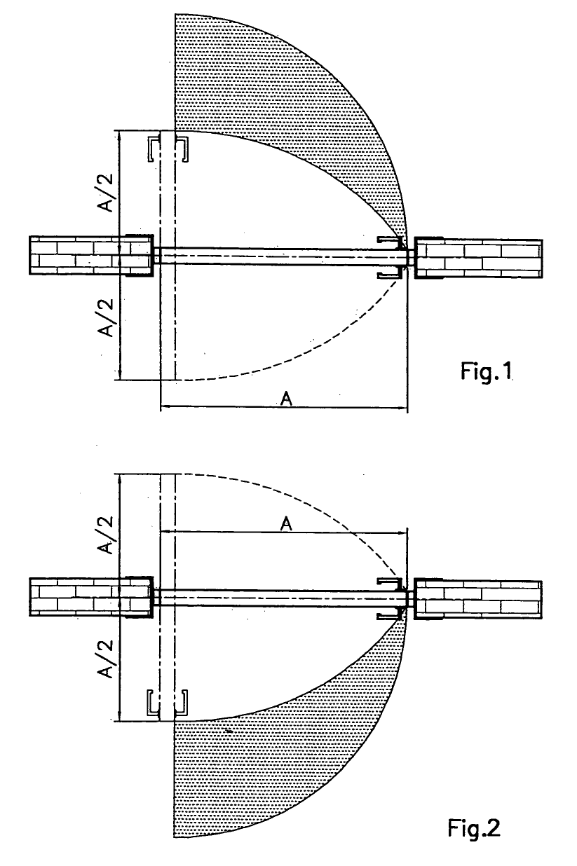

FIGS. 1 to 6 show views from above of the device according to various configurations.

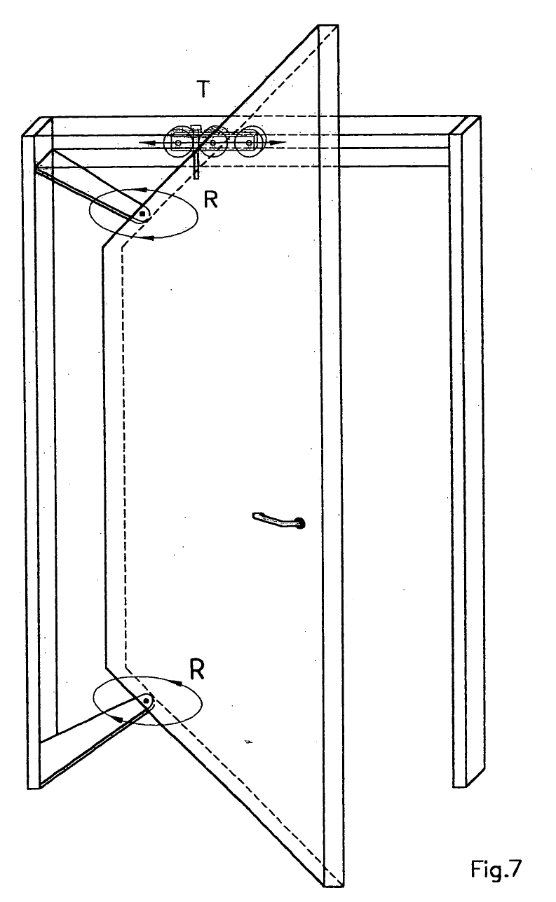

FIG. 7 shows schematically the movements of the door.

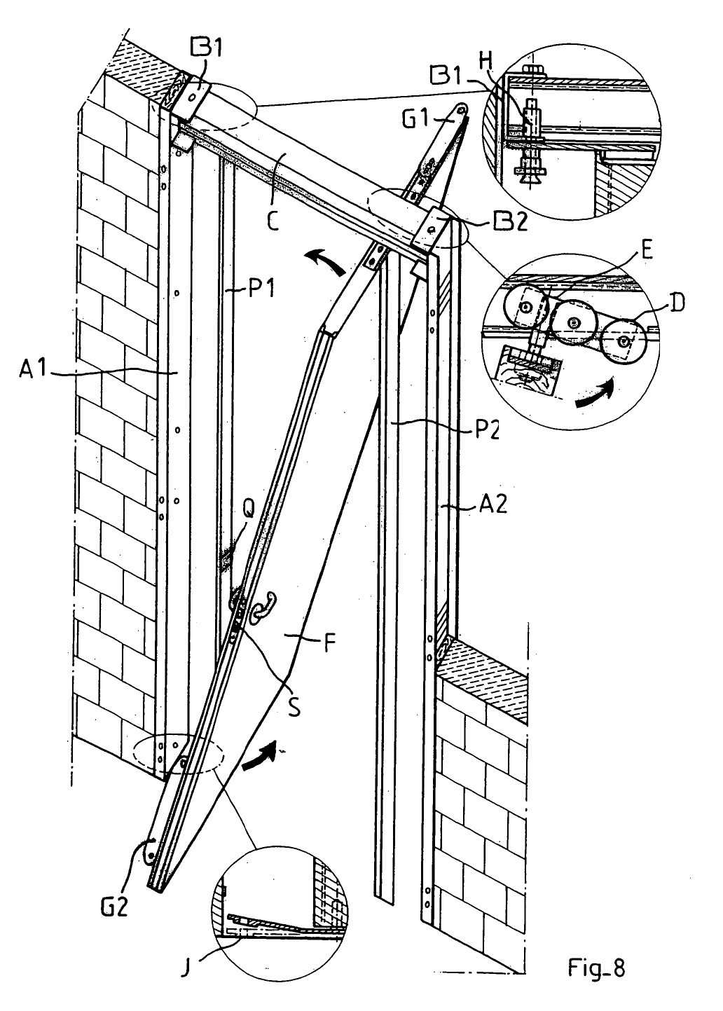

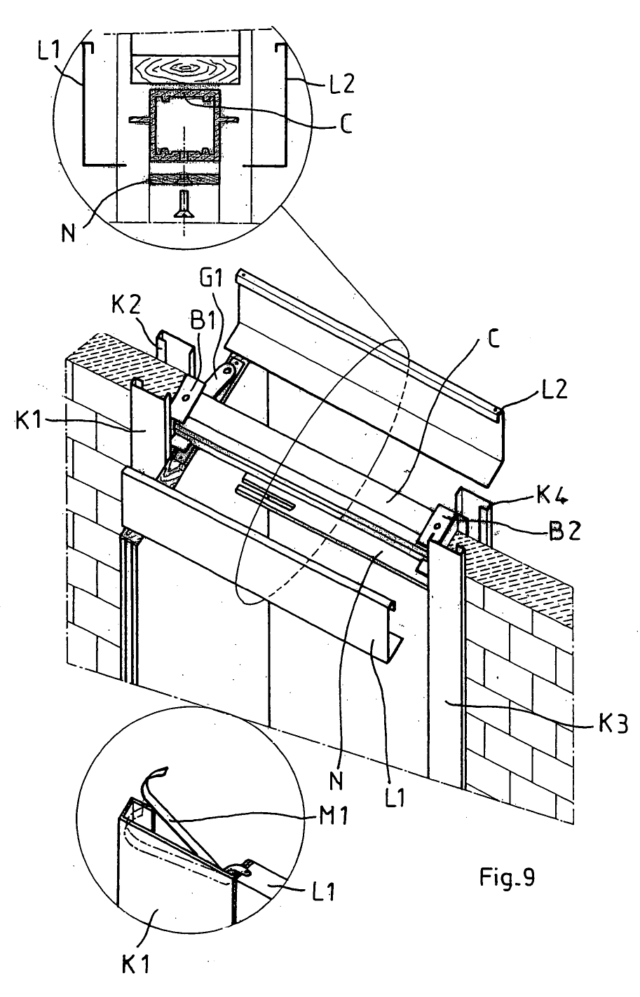

FIGS. 8 and 9 show the phases of mounting and certain members of the invention.

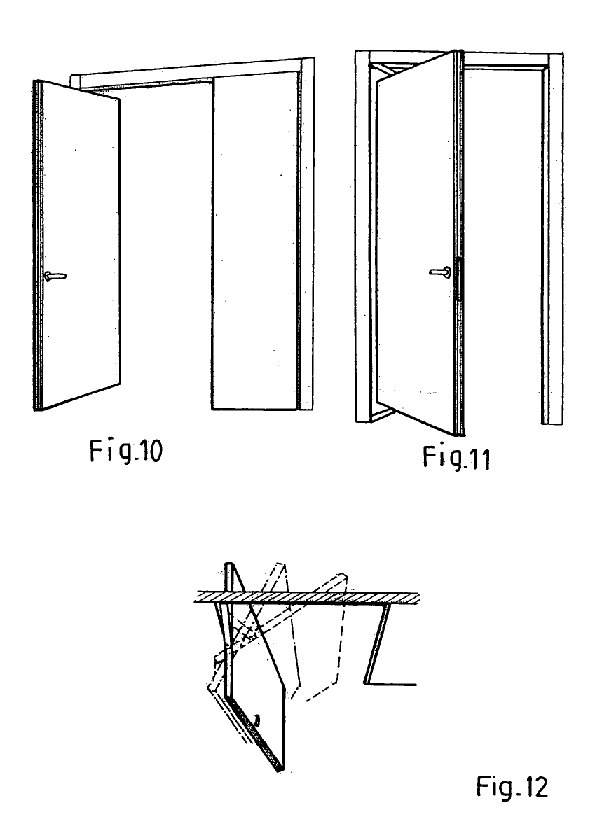

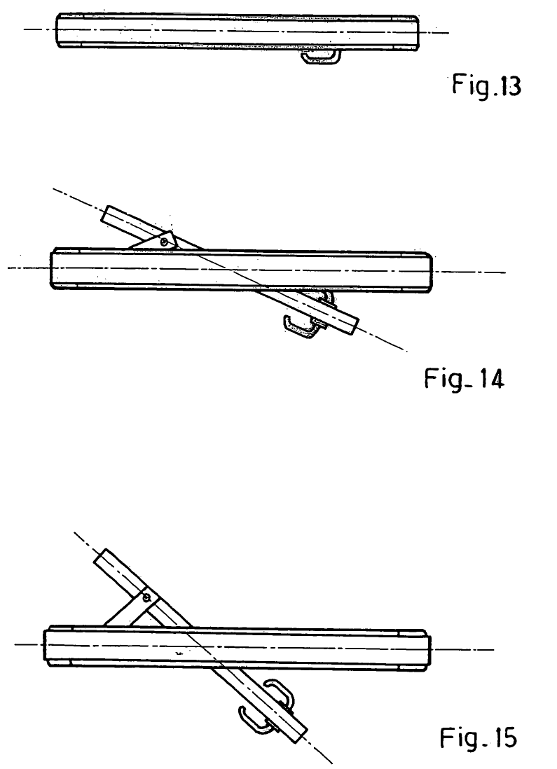

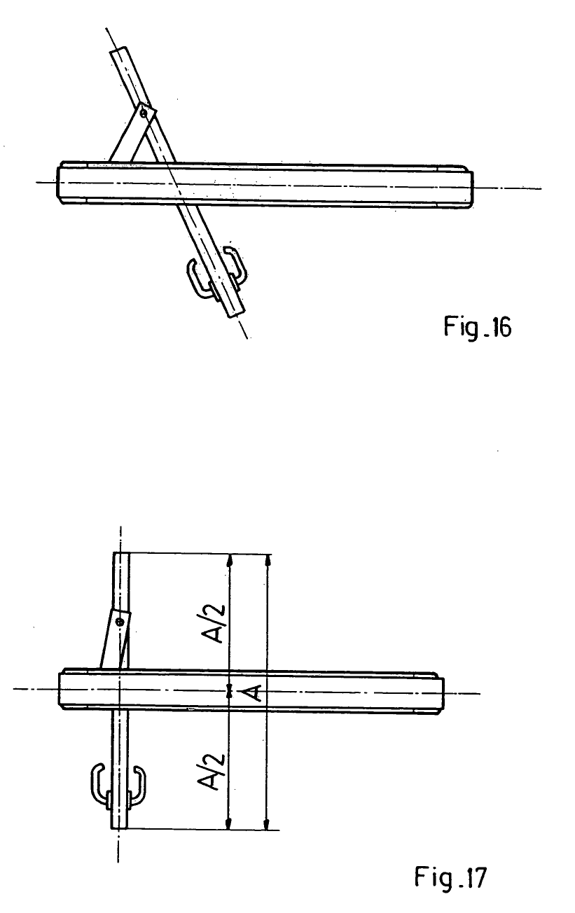

FIGS. 10 to 17 show particular embodiments of the invention.

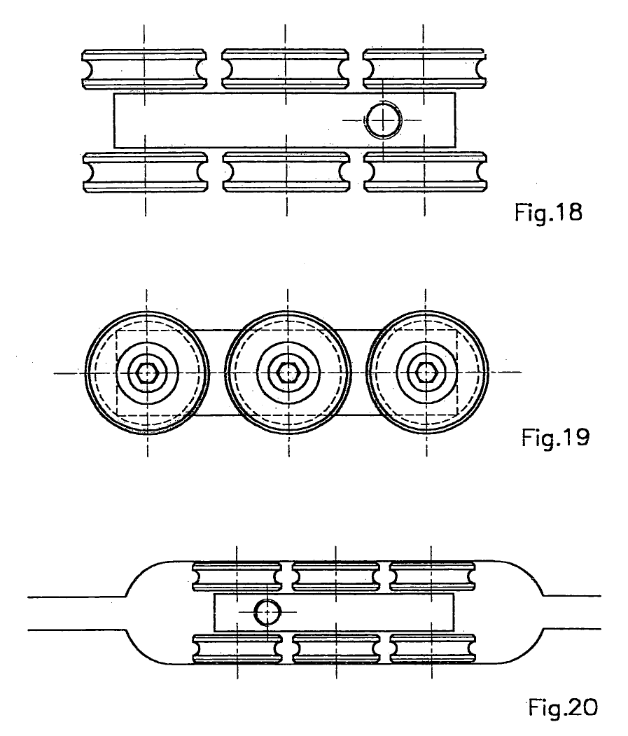

FIGS. 18 to 21 show more particularly the translation carriage.

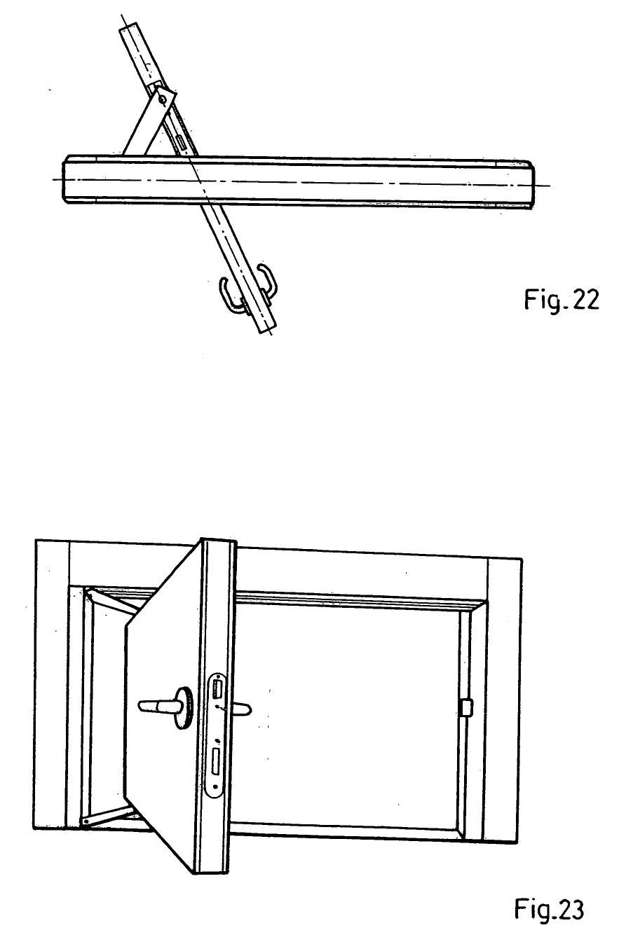

FIGS. 22 and 23 show from above and from the front another modification of the device.

An innovative technology:

The door reduces the space it takes up during opening, thanks to a simultaneous movement of rotation R and of translation T (see FIG. 2).

The translation T takes place thanks to a guided carriage (D):

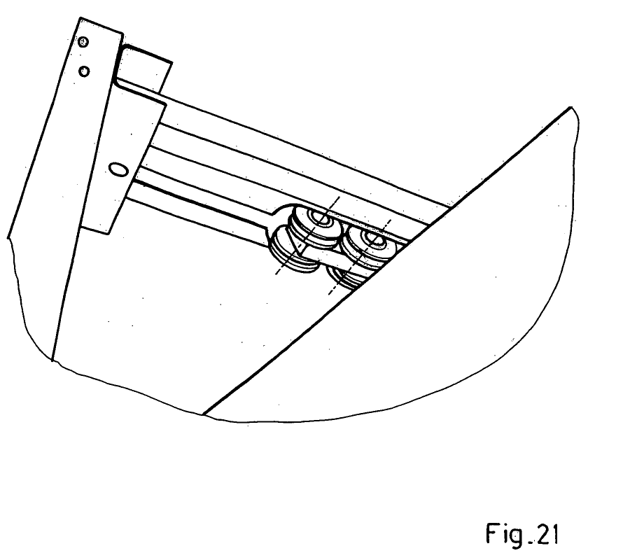

1. within a rail (C) (FIGS. 20, 21) itself embedded in the upper lintel (fixed frame) then fixed to two U shaped plates (B1 & B2) themselves fixed to the center, on the two vertical uprights (A1 & A2)

2. with the help of a guide (N), fixed in the lower position of the rail (C)

The swinging panel (F) is connected in the upper position to the carriage (D) by an axle (E).

The translation T of the swinging panel (F) is thus possible.

The rotation R takes place thanks to two links (G1 & G2), on the one hand fixed respectively on their axles (H & J) of the U shaped plates (B1 & B2) fixed themselves on the vertical upright (A1), and on the other hand are fixed on the swinging panel (F) in the upper and lower position of the door frame.

The length of the links (G1 & G2) determines the measurements A & B thereby permitting saving space on one side or the other of the door.

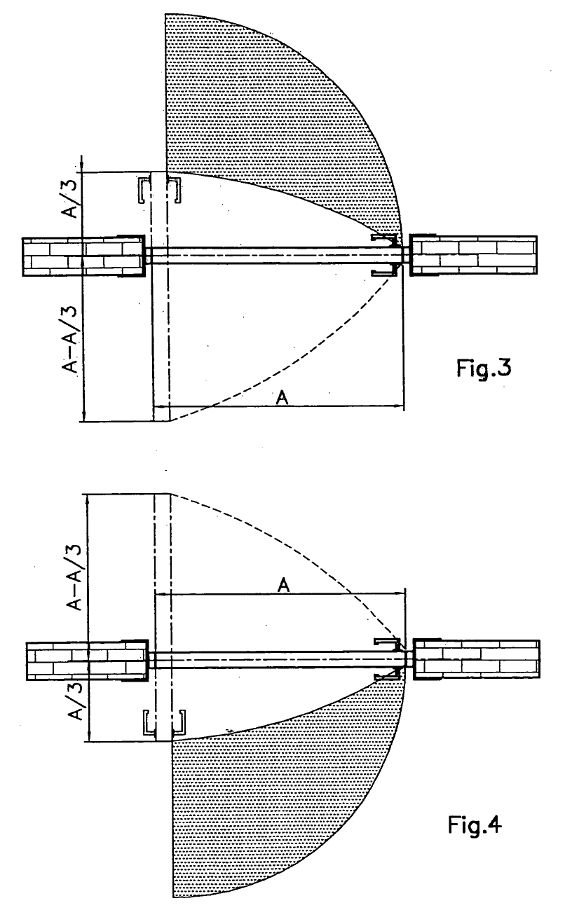

The size of the opening can be reduced by 50% (see FIGS. 1, 2, 13 to 17) to 66% (see FIGS. 3 & 4). There is shown in broken line the saving of space.

It is the length of the two links (G1 & G2), the position of their securements on the door, combined with the position of securement of the carriage (D) on the swinging panel (F) which determines the percentage of space saved.

A “pull-push” lock (S)+“2 handles”+its volt (Q) embedded in the vertical strip (P1) and the position of the two links (G1 & G2) in prolongation of the swinging panel (F), which is to say the closed door, which creates a blockage of the swinging panel (F) without however preventing the double opening function “pull-push”. The vertical strips (P1 & P2) permit the joining and a relative sealing with the swinging panel (F).

Four vertical covers (K1, K2, K3,K4) as well as two horizontal covers (L1 & L2) interconnected by four springs (M1, M2, M3 & M4) permit a better appearance of the assembly.

The device comprises four vertical covers (K1, K2, K3 & K4) fixed against the two vertical uprights (A1 & A2) as well as two horizontal covers (L1 & L2) fixed between the rail (C).

Option:

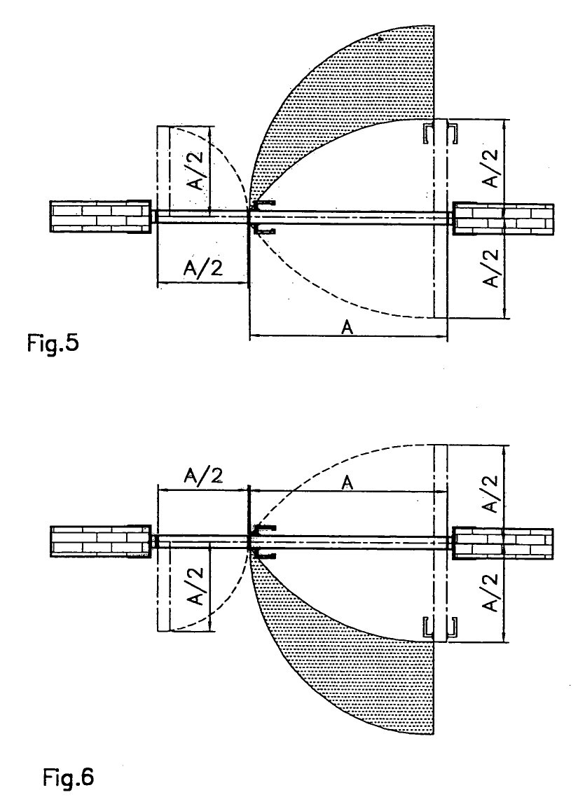

A second panel having the same size as the door (50% of the width of the door) (see FIGS. 5 & 6-FIG. 10). This option is very useful for hospitals. A removable abutment permits selecting between opening by “pushing” and opening by “pulling”.

### REFERENCES

A1, A2. Vertical uprights

B1, B2. U shaped plates

C. Rail

D. Carriage

E. Axle

F. Swinging panel

G1, G2. Links

H. Axle

J. Axle

K1, K2, K3, K4. Vertical covers

L1, L2. Horizontal covers

M1, M2, M3, M4. Springs

N. guide

P1, P2. Vertical strips

Q. Bolt

R. Rotation

S. Lock

T. Translation

1. Device for “pulling or pushing” a swinging panel (F) of a door comprising:
a link (G2) in the lower position of the door, said link (G2) being fixed in rotation by one end on the lower portion of the swinging panel (F) and by the other end on an upright (A1) of the door frame,
a link (G1) in the upper position of the door, said link (G1) being fixed in rotation by one end on the upper portion of the swinging panel (F) and by the other end to the upright (A1),
a carriage (D) guided in translation within a rail (C) embedded in the lintel of the door and fixed on the upper portion of the swinging panel (F) by an axle (E), characterized by the fact that it comprises:
a first U shaped plate (B1) secured to the upright (A1) and on which is fixed in rotation the other end of the link (G1)
a second U shaped plate (B2) secured to the other upright (A2) of the door, said U shaped plates (B1, B2) fixed and supporting the rail (C).

2. Device according to claim 1 characterized by the fact that it comprises a guide (N) in the lower position of the rail (C).

3. Device according to any one of claims 1 or 2 characterized by the fact that it comprises:
four vertical covers (K1, K2, K3 and K4) fixed against the two vertical uprights (Al, A2) of the door,
two horizontal covers (L1, L2) fixed on the rail (C),
four springs (M1, M2, M3 and M4) permitting assembling in the upper position the four vertical covers (K1, K2, K3 and K4) to the two horizontal covers (L1, L2).

4. Device according to any one of claims 1 to 3 characterized by the fact that it comprises two vertical strips (P1, P2) each fixed to the center of a vertical upright (A1, A2).
